(19) United States
(12) Patent Application Publication
(10) Pub. No.: US 2016/0024362 A1
(43) Pub. Date: Jan. 28, 2016

(54) COMPOSITIONS AND METHOD FOR REFRIGERATION

(71) Applicants: Yun LIN, Shanghai (CN); Zhili LU, (US); Jun LIU, Shanghai (CN); Samuel F Yana MOTTA, (US); Xiangrui WANG, (US); Yongming NIU, Shanghai (CN); Andrew SUN, Shanghai (CN); Mark W. SPATZ, East Amherst, NY (US); Robert G. RICHARD, Hamburg, NY (US); Ankit SETHI, Mendham, NJ (US); HONEYWELL INTERNATIONAL INC., Morristown, NJ (US)

(72) Inventors: LU Zhili, Shanghai (CN); Jun LIU, Shanghai (CN); Samuel F. YANA MOTTA, East Amherst, NY (US); Xiangrui WANG, Shanghai (CN); Yongming NIU, Shanghai (CN); Andrew SUN, Shanghai (CN); Mark W. SPATZ, East Amherst, NY (US); Robert G. RICHARD, Hamburg (CN); SETHI Ankit, Mendham, NJ (US)

(21) Appl. No.: 14/775,717

(22) PCT Filed: Mar. 15, 2013
(86) PCT No.: PCT/CN2013/072691

§ 371 Date: Sep. 13, 2015

(51) Int. Cl. C09K 5/04; F25B 45/00

(52) U.S. Cl. CPC C09K 5/045; F25B 45/00; C09K 2205/22; C09K 2205/32; C09K 2205/40

(57) ABSTRACT

The present invention relates, in part, to heat transfer systems, methods and compositions which utilize a heat transfer fluid comprising: (a) HFO-1234ze; (b) HFC-227ea; and (c) optionally HFC-134a, wherein HFO-1234ze and HFC-227ea are provided in effective amounts to form an azeotrope or azeotrope-like composition.

### FIELD OF THE INVENTION

The present invention relates, at least in part, to heat transfer compositions, and in particular to heat transfer and/or refrigerant compositions which may be suitable as replacements for the existing refrigerant HFC-134a.

### BACKGROUND OF THE INVENTION

A portion of the global warming effect is associated with the use of working fluids that have been used in the mechanical refrigeration systems. In response to an international appeal for the application of low global warming potentials and high efficient working fluids, a number of governments have signed the Kyoto Protocol to phase down the working fluids of high global warming potentials and to reduce the CO₂ emissions.

HFC-134a is an important working fluid that is now widely used in many refrigeration applications, including the screw water chiller, centrifugal water chiller, heat pump water heater, dehumidifier, etc. Its Global Warming Potential (GWP), however, is estimated to be 1430, which is considered too high for continued use. In accordance with the Kyoto Protocol and other similar international initiatives, there has been an increasing need for new hydrofluorocarbon compounds and compositions of lower GWP to replace HFC-134a in these applications and also in other similar applications where HFC-134a is or may be used.

Flammability is an important property for the applications of screw water chiller, centrifugal water chiller, heat pump water heater, and dehumidifier, etc. First, existing standards make difficult the adoption of a flammable hydrofluorocarbon refrigerant. Second, the parts/components for such refrigeration apparatuses are insufficient for use with a flammable refrigerant and are expensive to replace. Third, the addition of an air-ventilation system and refrigerant leakage detectors would necessary to prevent refrigerant from catching fire and exploding in case of a refrigerant leak. Accordingly, it is desirable to provide a replacement refrigerant having low or no flammability.

Volumetric refrigeration capacity is also an important property in the replacement of HFC-134a, particularly in the applications above, because it has a big impact on the compressor size. A refrigerant having a small volumetric refrigeration capacity would need large size compressor, which would increase the refrigeration apparatus size and costs. Accordingly, it is desirable to provide a replacement refrigerant having a volumentric refrigeration capacity that is at or similar to that of HFC-134a.

The present invention addresses at least these foregoing needs.

### SUMMARY

Applicants have found that the above-noted needs, and other needs, can be satisfied by compositions, methods and systems of the present invention. In certain aspects, the present invention relates to a heat transfer composition comprising: (a) HFO-1234ze (in certain preferred embodiments trans-HFO-1234ze); (b) HFC-227ea; and (c) optionally HFC-134a, wherein HFO-1234ze and HFC-227ea are provided in effective amounts to form an azeotrope or azeotrope-like composition. In certain embodiments, the heat transfer compositions include (a) from about 80 wt. % to about 95 wt. % of HFO-1234ze; and (b) from about 5 wt. % to about 20 wt. % of HFC-227ea, with the weight percent being based on the total of the components (a)-(c) in the composition. In further embodiments, the heat transfer composition includes (a) from about 83 wt. % to about 92 wt. % of HFO-1234ze; and (b) from about 8 wt. % to about 17 wt. % of HFC-227ea, with the weight percent being based on the total of the components (a)-(c) in the composition. In even further embodiments, the heat transfer composition includes (a) from about 85 wt. % to about 90 wt. % of HFO-1234ze; and (b) from about 10 wt. % to about 15 wt. % of HFC-227ea, with the weight percent being based on the total of the components (a)-(c) in the composition. In even further preferred embodiments, the heat transfer composition includes (a) from about 88 wt. % to about 92 wt. % of HFO-1234ze; and (b) from about 8 wt. % to about 12 wt. % of HFC-227ea, with the weight percent being based on the total of the components (a)-(c) in the composition.

In certain embodiments of the foregoing, HFC-134a is included in the composition. In certain of such embodiments, the heat transfer composition includes (a) from about 60 wt. % to about 95 wt. % of HFO-1234ze; (b) from about 5 wt. % to about 20 wt. % of HFC-227ea, (c) from greater than about 0 wt. % to about 20 wt. % of HFC-134a, with the weight percent being based on the total of the components (a)-(c) in the composition. In further embodiments, the heat transfer composition includes (a) from about 68 wt. % to about 92 wt. % of HFO-1234ze; (b) from about 8 wt. % to about 17 wt. % of HFC-227ea, (c) from greater than 0 wt. % to about 15 wt. % of HFC-134a, with the weight percent being based on the total of the components (a)-(c) in the composition. In even further embodiments, the heat transfer composition includes comprising (a) from about 75 wt. % to about 90 wt. % of HFO-1234ze; (b) from about 10 wt. % to about 15 wt. % of HFC-227ea, (c) from greater than about 0 wt. % to about 10 wt. % of HFC-134a, with the weight percent being based on the total of the components (a)-(c) in the composition. In even further embodiments, the heat transfer composition includes (a) from about 80 wt. % to about 90 wt. % of HFO-1234ze; (b) from about 10 wt. % to about 15 wt. % of HFC-227ea, (c) from greater than about 0 wt. % to about 5 wt. % of HFC-134a, with the weight percent being based on the total of the components (a)-(c) in the composition.

Applicants have unexpectedly found the combination of components in the present compositions, especially within the preferred ranges specified herein, are capable of at once achieving a combination of important and difficult to achieve refrigerant performance properties that cannot be achieved by any one of the components alone. For example, the preferred compositions of the present invention are at once Class 1 with respect to flammability and have a desirably low GWP. They also exhibit volumetric refrigeration capacity that is the same as, similar to, or within commercially tolerable deviation from HFC-134a (also referred to herein as “R-134a”).

Any one or more of the compositions, systems, or methods of the present invention may also be provided with one or more co-refrigerant. Non-limiting examples of such co-refrigerants may include one or a combination of HFC-152a, HFO-1234yf, HFC-236ea, HFC-245fa, and CO2. In certain aspects, such co-refrigerants may be provided in an amount of less than 5 wt. % of the total weight of the composition.

The present invention also relates to methods and systems which utilize the compositions of the present invention, including methods and systems for heat transfer and for retrofitting existing heat transfer systems. Certain preferred method aspects of the present invention relate to methods of providing cooling in existing refrigeration systems. Other method aspects of the present invention provide methods of retrofitting an existing systems designed to contain or containing R-134a refrigerant comprising introducing a composition of the present invention into the system without substantial engineering modification of said existing refrigeration system. In certain non-limiting aspects, the refrigeration system may include a unit selected from the group consisting of small refrigeration systems, low- and medium-temperature refrigeration systems, stationary air conditioners, automotive air conditioners, domestic refrigerator/freezers, chillers, heat pumps, vending machines, screw water chillers, centrifugal water chillers, medium pressure centrifugal chillers, heat pump water heaters, and dehumidifiers.

The term “HFO-1234” is used herein to refer to all tetrafluoropropenes. Among the tetrafluoropropenes are included 1,1,1,2-tetrafluoropropene (HFO-1234yf) and both cis- and trans-1,1,1,3-tetrafluoropropene (HFO-1234ze). The term HFO-1234ze is used herein generically to refer to 1,1,1,3-tetrafluoropropene, independent of whether it is the cis- or trans-form. The terms “cisHFO-1234ze” and “transHFO-1234ze” are used herein to describe the cis- and trans-forms of 1,1,1,3-tetrafluoropropene respectively. The term “HFO-1234ze” therefore includes within its scope cisHFO-1234ze, transHFO-1234ze, and all combinations and mixtures of these.

The term “HFC-134a” is used herein to refer to 1,1,1,2-tetrafluoroethane.

Additional advantages and embodiments will be readily apparent to the skilled artisan based on the disclosure provided herein.

### BRIEF DESCRIPTION OF THE DRAWINGS

FIG. 1 illustrates flammability limits of compositions including HFC-227ea and HFO-1234ze.

### DETAILED DESCRIPTION OF PREFERRED EMBODIMENTS

One refrigerant that has been commonly used in many heating and cooling systems, including small refrigeration systems (including small commercial refrigeration systems), low- and medium-temperature refrigeration systems, stationary air conditioners, automotive air conditioners, domestic refrigerator/freezers, chillers, heat pumps, vending machines, screw water chillers, centrifugal water chillers, heat pump water heaters, dehumidifiers, and the like, is HFC-134a, which has an estimated high Global Warming Potential (GWP) of 1430. Applicants have found that the compositions of the present invention satisfy in an exceptional and unexpected way the need for alternatives and/or replacements for refrigerants in such applications, particularly and preferably HFC-134a. Preferred compositions at once have lower GWP values and provide non-flammable, non-toxic fluids that have a close match in volumetric capacity to HFC-134a in such systems.

In certain preferred forms, compositions of the present invention have a Global Warming Potential (GWP) of not greater than about 1,000, more preferably not greater than about 700, and even more preferably about 600 or less. As used herein, “GWP” is measured relative to that of carbon dioxide and over a 100 year time horizon, as defined in “The Scientific Assessment of Ozone Depletion, 2002, a report of the World Meteorological Association's Global Ozone Research and Monitoring Project,” which is incorporated herein by reference.

In certain preferred forms, the present compositions also preferably have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

Heat Transfer Compositions

The compositions of the present invention are generally adaptable for use in heat transfer applications. That is, in certain non-limiting aspects, they may be used as a heating and/or cooling medium, but are particularly well adapted for use, as mentioned above, in heating and cooling systems that have heretofore used HFC-134a. Examples of such systems include, but are not limited to, small refrigeration systems, low- and medium-temperature refrigeration system, stationary air conditioners, automotive air conditioners, domestic refrigerator/freezers, chillers, heat pumps, vending machines, screw water chillers, centrifugal water chillers, heat pump water heaters, dehumidifiers, and the like.

In certain preferred embodiments, compositions of the present invention comprise, consist essentially of, or consist of: (a) 1,3,3,3-tetrafluoropropene (HFO-1234ze); (b) heptfluoropropane (HFC-227ea); and (c) optionally tetrafluoroethane (HFC-134a). Each of these components may be provided in any amount that renders it useful as a refrigerant composition, particularly as a replacement for HFC-134a in existing refrigerant systems, and even more particularly in small refrigeration systems, low- and medium-temperature refrigeration systems, stationary air conditioners, automotive air conditioners, domestic refrigerator/freezers, chillers, heat pumps, vending machines, screw water chillers, centrifugal water chillers, heat pump water heaters, dehumidifiers, and similar systems that use or can use HFC-134a as a refrigerant.

HFO-1234ze may be provided as the cis isomer, the trans isomer, or a combination of the cis and trans isomers. In certain aspects, it is provided in an amount of from about 10 wt. % to less than 100 wt. % by weight of the compositions, in certain preferred aspects in an amount of from about 40 wt. % to less than about 100 wt. % by weight of the compositions, in further preferred aspects in an amount of from about 50 wt. % to about 99 wt. % by weight of the compositions, and in even further preferred aspects in an amount of from about 65 wt. % to about 95 wt. % by weight of the compositions.

HFC-227ea may be provided in an amount of from greater than 0 wt. % to about 90 wt. % by weight of the compositions, in certain preferred aspects in an amount of from greater than 0 wt. % to about 75 wt. % by weight of the compositions, in further preferred aspects in an amount of from greater than 0 wt. % to about 50 wt. % by weight of the compositions, in further preferred aspects in an amount of from greater than 1 wt. % to about 40 wt. % by weight of the compositions, and in even further preferred embodiments from about 5 wt. % to about 35 wt. % by weight of the compositions

HFC-134a may be provided in an amount of from 0 wt. % to about 90 wt. % by weight of the compositions, in certain preferred aspects in an amount of from 0 wt. % to about 50 wt. % by weight of the compositions, in further preferred aspects in an amount of from 0 wt. % to about 25 wt. % by weight of the compositions.

Applicants have found that use of the components of the present invention within the broad and preferred ranges described herein is important to obtaining the difficult to achieve combinations of properties exhibited by the present compositions, particularly in the preferred systems and methods, and that use of these same components but substantially outside of the identified ranges can have a deleterious effect on one or more of the important properties of the compositions of the invention. In highly preferred embodiments, highly preferred combinations of properties are achieved for compositions having a weight ratio of HFC-227ea:HFC-1234ze, and preferably of trans-HFC-1234ze, of from about 1:1 to about 1:20, with a ratio of from about 1:3 to about 1:17 being preferred in certain embodiments. In further embodiments, highly preferred combinations of properties are achieved for compositions having a weight ratio of HFC-134a:HFC-1234ze, and preferably of trans-HFC-1234ze, of from about 1:1 to about 1:20, with a ratio of from about 1:4 to about 1:17 being preferred in certain embodiments.

Applicants have further found that the difficult to achieve combinations of properties are also achieved when compositions comprise or consist essentially of HFC-227ea and HFC-1234ze, which are provided in effective amounts to form azeotrope or azetrope-like compositions.

As used herein, the term “azeotrope-like” relates to compositions that are strictly azeotropic or that generally behave like azeotropic mixtures. An azeotropic mixture is a system of two or more components in which the liquid composition and vapor composition are equal at the stated pressure and temperature. In practice, this means that the components of an azeotropic mixture are constant-boiling or essentially constant-boiling and generally cannot be thermodynamically separated during a phase change. The vapor composition formed by boiling or evaporation of an azeotropic mixture is identical, or substantially identical, to the original liquid composition. Thus, the concentration of components in the liquid and vapor phases of azeotrope-like compositions change only minimally, if at all, as the composition boils or otherwise evaporates. In contrast, boiling or evaporating non-azeotropic mixtures changes the component concentrations in the liquid phase to a significant degree.

As used herein, the term “consist essentially of” or “consisting essentially of,” with respect to the components of an azeotrope or azeotrope-like composition, means the composition contains the indicated components in an azeotropic or azeotrope-like ratio, and may contain additional components provided that the additional components do not form new azeotrope or azeotrope-like systems. For example, azeotrope or azeotrope-like mixtures consisting essentially of two compounds are those that form binary azeotropes, which optionally may include one or more additional components, provided that the additional components do not render the mixture non-azeotropic and do not form an azeotrope with either or both of the compounds.

The term “effective amounts” as used herein refers to the amount of each component which, upon combination with the other component, results in the formation of an azeotrope or azeotrope-like composition of the present invention.

In certain aspects of the present invention, the effective amounts of HFO-1234ze (particularly trans-HFO-1234ze) and HFC-227ea are any amount demonstrating azeotrope or azeotrope-like behavior. Non-limiting examples of such amounts are set forth in U.S. Pat. No. 7,825,081, the contents of which are incorporated herein in its entirety. That is, in certain preferred embodiments, such azeotrope or azeotrope-like compositions comprise, and preferably consisting essentially of, from greater than zero to about 75 wt. % HFC-227ea and from about 25 to less than 100 wt. % transHFO-1234ze, more preferably from greater than zero to about 60 wt. % HFC-227ea and from about 40 to less than 100 wt. % transHFC-1234ze, and even more preferably from about 1 to about 40 wt. % HFC-227ea and from about 60 to about 99 wt. % transHFO-1234ze. In certain preferred embodiments, the azeotrope-like compositions comprise, and preferably consist essentially of, from about 5 to about 35 wt. % HFC-227ea and from about 65 to about 95 wt. % transHFO-1234ze. Such HFO-1234/HFC-227ea compositions have a boiling of from about −17° C. to about −19° C. at about 14 psia. Preferably, the HFO-1234/HFO-227ea compositions of the present invention have a boiling of about −18° C. ±2° C. at about 14 psia, and even more preferably about −18° C.±1° C. at about 14 psia.

In further preferred aspects of the present invention, HFO-1234ze (and in certain embodiments, trans-HFO-1234ze) may be provided in an amount of from about 80 wt. % to about 95 wt. % by weight and HFC-227ea in an amount from about 5 wt. % to about 20 wt. % by weight, based on the total weight of HFO-1234ze and HFC-227ea. In further aspects, HFO-1234ze (and in certain embodiments, trans-HFO-1234ze) may be provided in an amount of from about 83 wt. % to about 92 wt. % by weight and HFC-227ea in an amount from about 8 wt. % to about 17 wt. % by weight, based on the total weight of HFO-1234ze and HFC-227ea. In even further embodiments, HFO-1234ze (and in certain embodiments, trans-HFO-1234ze) may be provided in an amount of from about 85 wt. % to about 90 wt. % by weight and HFC-227ea in an amount from about 10 wt. % to about 15 wt. % by weight, based on the total weight of HFC-1234ze and HFC-227ea. In even further embodiments, HFO-1234ze (and in certain embodiments, trans-HFO-1234 ze) may be provided in an amount of from about 88 wt. % to about 92 wt. % by weight and HFC-227ea in an amount from about 8 wt. % to about 12 wt. % by weight, based on the total weight of HFC-1234ze and HFC-227ea.

In embodiments where HFC-134a is present HFO-1234ze (and in certain embodiments, trans-HFO-1234ze) may be provided in an amount of from about 60 wt. % to about 95 wt. % by weight; HFC-227ea in an amount from about 5 wt. % to about 20 wt. % by weight; and HFC-134a in an amount from greater than 0 wt. % to about 20 wt. % by weight, based on the total weight of HFO-1234ze, HFC-227ea, and HFC-134a. In further aspects, HFO-1234ze (and in certain embodiments, trans-HFO-1234ze) may be provided in an amount of from about 68 wt. % to about 92 wt. % by weight; HFC-227ea in an amount from about 8 wt. % to about 17 wt. % by weight and HFC-134a in an amount from greater than about 0 wt. % to about 15 wt. % by weight, based on the total weight of HFO-1234ze, HFC-227ea, and HFC-134a. In even further embodiments, HFO-1234ze (and in certain embodiments, trans-HFO-1234ze) may be provided in an amount of from about 75 wt. % to about 90 wt. % by weight; HFC-227ea in an amount from about 10 wt. % to about 15 wt. % by weight and HFC-134a in an amount from greater than about 0 wt. % to about 10 wt. % by weight, based on the total weight of HFO-1234ze, HFC-227ea, and HFC-134a. In even further embodiments, HFO-1234ze (and in certain embodiments, trans-HFO-1234ze) may be provided in an amount of from about 80 wt. % to about 90 wt. % by weight; HFC-227ea in an amount from about 10 wt. % to about 15 wt. % by weight and HFC-134a in an amount from greater than about 0 wt. % to about 5 wt. % by weight, based on the total weight of HFO-1234ze, HFC-227ea, and HFC-134a.

Although it is contemplated that either isomer of HFO-1234ze may be used to advantage in certain aspects of the present invention, applicants have found that it is preferred in certain embodiments that the HFO-1234ze comprise transHFO-1234ze, and preferably comprise transHFO-1234ze in major proportion, and in certain embodiments consist essentially of transHFO-1234ze. As used herein, the term trans-HFO-1234ze with respect to a component of an azeotrope or azeotrope-like mixture, means the amount trans-HFO-1234ze relative to all isomers of HFO-1234ze in the azeotrope or azeotrope-like compositions is at least about 95%, more preferably at least about 98%, even more preferably at least about 99%, even more preferably at least about 99.9%. In certain preferred embodiments, the trans-HFO-1234ze component in azeotrope or azeotrope-like compositions of the present invention is essentially pure trans-HFO-1234ze.

The azeotrope or azeotrope-like compositions of the present invention can be produced by combining effective amounts of trans-HFO-1234ze with one or more other components, preferably in fluid form. Any of a wide variety of methods known in the art for combining two or more components to form a composition can be adapted for use in the present methods. For example, trans-HFO-1234ze and any of the additional components provided herein can be mixed, blended, or otherwise combined by hand and/or by machine, as part of a batch or continuous reaction and/or process, or via combinations of two or more such steps. In light of the disclosure herein, those of skill in the art will be readily able to prepare azeotrope or azeotrope-like compositions according to the present invention without undue experimentation.

As mentioned above, applicants have found that the compositions of the present invention are capable of achieving a difficult combination of properties, including particularly low GWP. By way of non-limiting example, the following Table A illustrates the substantial improvement the GWP of certain compositions of the present invention in comparison to the GWP of HFC-134a, which has a GWP of 1430.

TABLE A

| Composition of the Invention | | | GWP as a |
|---|---|---|---|
| (weight fraction, based on | | | Percentageof |
| identified components) | Name | GWP | R134a GWP |
| R134a | R134a | 1430 | 100% |
| 1234ze | A1 | 6 | 0.4% |
| R134a/1234ze (0.42/0.58) | A2 | 604 | 42.2% |
| R227ea/1234ze (0.05/0.95) | A3 | 167 | 11.7% |
| R227ea/1234ze (0.1/0.90) | A4 | 327 | 22.9% |
| R227ea/1234ze (0.12/0.88) | A5 | 392 | 27.4% |
| R227ea/1234ze (0.15/0.85) | A6 | 488 | 34.1% |
| R227ea/1234ze (0.20/0.80) | A7 | 649 | 45.4% |
| R227ea/1234ze/R134a (0.10/0.85/0.05) | A8 | 399 | 28.0% |
| R227ea/1234ze/R134a (0.10/0.80/0.10) | A9 | 470 | 32.9% |
| R227ea/1234ze/R134a (0.10/0.75/0.15) | A10 | 541 | 37.8% |
| R227ea/1234ze/R134a (0.12/0.83/0.05) | A11 | 463 | 32.4% |
| R227ea/1234ze/R134a (0.12/0.78/0.10) | A12 | 534 | 37.3% |
| R227ea/1234ze/R134a (0.12/0.73/0.15) | A13 | 605 | 42.3% |
| R227ea/1234ze/R134a (0.15/0.80/0.05) | A14 | 559 | 39.1% |
| R227ea/1234ze/R134a (0.15/0.75/0.10) | A15 | 631 | 44.1% |
| R227ea/1234ze/R134a (0.15/0.70/0.15) | A16 | 702 | 49.1% |

The compositions of the present invention may include other components for the purpose of enhancing or providing certain functionality to the composition, or in some cases to reduce the cost of the composition. For example, the present compositions may include co-refrigerants, lubricants, stabilizers, metal passivators, corrosion inhibitors, flammability suppressants, and other compounds and/or components, and the presence of all such compounds and components is within the broad scope of the invention.

In certain preferred embodiments, the refrigerant compositions according to the present invention, especially those used in vapor compression systems, include a lubricant, generally in amounts of from about 30 to about 50 percent by weight of the composition, and in some case potentially in amount greater than about 50 percent and other cases in amounts as low as about 5 percent. Furthermore, the present compositions may also include a compatibilizer, such as propane, for the purpose of aiding compatibility and/or solubility of the lubricant. Such compatibilizers, including propane, butanes and pentanes, are preferably present in amounts of from about 0.5 to about 5 percent by weight of the composition. Combinations of surfactants and solubilizing agents may also be added to the present compositions to aid oil solubility, as disclosed by U.S. Pat. No. 6,516,837, the disclosure of which is incorporated by reference. Commonly used refrigeration lubricants such as Polyol Esters (POEs) and Poly Alkylene Glycols (PAGs), polyalkylene glycol esters (PAG esters), PAG oils, silicone oil, mineral oil, polyalkyl benzenes (PABs), polyvinyl ethers (PVEs), poly(alpha-olefin) (PAO), and combinations thereof that are used in refrigeration machinery with hydrofluorocarbon (HFC) refrigerants may be used with the refrigerant compositions of the present invention. Commercially available mineral oils include Witco LP 250 (registered trademark) from Witco, Zerol 300 (registered trademark) from Shrieve Chemical, Sunisco 3GS from Witco, and Calumet R015 from Calumet. Commercially available alkyl benzene lubricants include Zerol 150 (registered trademark). Commercially available esters include neopentyl glycol dipelargonate, which is available as Emery 2917 (registered trademark) and Hatcol 2370 (registered trademark). Other useful esters include phosphate esters, dibasic acid esters, and fluoroesters. In some cases, hydrocarbon based oils are have sufficient solubility with the refrigerant that is comprised of an iodocarbon, the combination of the iodocarbon and the hydrocarbon oil might more stable than other types of lubricant. Such combination may therefore be advantageous. Preferred lubricants include polyalkylene glycols and esters. Polyalkylene glycols are highly preferred in certain embodiments because they are currently in use in particular applications such as mobile air-conditioning. Of course, different mixtures of different types of lubricants may be used.

Additional ingredients may include, but are not limited to, dispersing agents, cell stabilizers, cosmetics, polishing agents, medicaments, cleaners, fire retarding agents, colorants, chemical sterilants, stabilizers, polyols, polyol premix components and combinations thereof.

In certain preferred embodiments, the present compositions include, in addition to the compounds described above, one or more of the following as co-refrigerant:

Trichlorofluoromethane (CFC-11)

Dichlorodifluoromethane (CFC-12)

Difluoromethane (HFC-32)

Pentafluoroethane (HFC-125)

Difluoroethane (HFC-152a)

1,1,1,3,3,3-hexafluoropropane (HFC-236fa)

1,1,1,2,3,3-hexafluoropropane (HFC-236ea)

1,1,1,3,3-pentafluoropropane (HFC-245fa)

1,1,1,3,3-pentafluorobutane (HFC-365mfc)

2,3,3,3-tetrafluoropropene (HFO-1234yf)

water

CO₂

In certain aspects, such co-refrigerants may be provided in amounts of from greater than 0 to about 10 percent by weight of the composition, in further embodiments from greater than about 0 to about 5 percent by weight of the compositions, in further embodiments, from greater than about 0 to less than about 5 percent by weight of the composition, and in further embodiments from about 0.5 to less than about 5 percent by weight of the composition. In certain preferred embodiments the co-refrigerant may be selected from difluoroethane (HFC-152a); 2,3,3,3-tetrafluoropropene (HFO-1234yf); 1,1,1,2,3,3-hexafluoropropane (HFC-236ea); 1,1,1,3,3-pentafluoropropane (HFC-245fa); CO2; and combinations thereof. Such co-refrigerants may be provided in any amount, such as those above, but in certain embodiments is provided in an amount of greater than about 0 to about 5 percent by weight of the compositions, in further embodiments from greater than about 0 to less than about 5 percent by weight of the composition, and in further embodiments from about 0.5 to less than about 5 percent by weight of the composition. Such co-refrigerants and amount are not necessarily limiting to the invention and other co-refrigerants may be used in addition to or instead of any or more of the above-noted examples.

Heat Transfer Methods and Systems

The preferred heat transfer methods generally comprise providing a composition of the present invention and causing heat to be transferred to or from the composition, either by sensible heat transfer, phase change heat transfer, or a combination of these. For example, in certain preferred embodiments the present methods provide refrigeration systems comprising a refrigerant of the present invention and methods of producing heating or cooling by condensing and/or evaporating a composition of the present invention. In certain preferred embodiments, the systems and methods for heating and/or cooling, including cooling of other fluid either directly or indirectly or a body directly or indirectly comprise compressing a refrigerant composition of the present invention and thereafter evaporating said refrigerant composition in the vicinity of the article to be cooled.

In certain preferred aspects, the present methods, systems and compositions are thus adaptable for use in connection with a wide variety of heat transfer systems in general and refrigeration systems in particular, such as air-conditioning, refrigeration, heat-pump systems, dehumidifiers and chillers, including centrifugal-compressor chillers as shown in example 3. Other types of chillers such as screw-compressor chillers, positive-displacement compressor chillers are also included as shown in typical example 5. In certain preferred embodiments, the compositions of the present invention are used in refrigeration systems originally designed for use with an HFC refrigerant, such as, for example, R-134a. The preferred compositions of the present invention tend to exhibit many of the desirable characteristics of R-134a but have a GWP that is substantially lower than that of R-134a while at the same time maintaining non-flammability and having a capacity that is substantially similar to or substantially matches, and preferably is as high as or higher than R-134a. In particular, applicants have recognized that certain preferred embodiments of the present compositions tend to exhibit relatively low global warming potentials (“GWPs”), preferably less than about 1,000, and more preferably not greater than about 700, and even more preferably not greater than about 600.

In certain other preferred embodiments, the present compositions are used in refrigeration systems originally designed for use with R-134a. Preferred refrigeration compositions of the present invention may be used in refrigeration systems containing a lubricant used conventionally with R-134a or may be used with other lubricants traditionally used with HFC refrigerants. As used herein the term “refrigeration system” refers generally to any system or apparatus, or any part or portion of such a system or apparatus, which employs a refrigerant to provide cooling. Such refrigeration systems include, for example, a small refrigeration system (including small commercial refrigeration systems), a medium-temperature refrigeration system, a stationary air conditioner, automotive air conditioner, domestic refrigerator/freezer, chiller, heat pump, vending machine, screw water chiller, centrifugal water chiller, positive displacement compressor chillers, heat pump water heater, dehumidifiers, and the like.

As mentioned above, the present invention achieves exceptional advantages in connection with small commercial refrigeration systems (including low and medium temperatures systems) as well as in chillers. Non-limiting examples of such small refrigeration systems are provided in Examples 1 and 2 (medium temperature applications), below. An example of a chiller application is provided in Example 3, below. These examples below provide typical conditions and parameters that are used for such applications. These conditions, however, are not considered limiting to the invention, as one of skill in the art will appreciate that they may be varied based on one or more of a myriad of factors, including but not limited to, ambient conditions, intended application, time of year, and the like. Such examples are also not necessarily limiting to the definition of the term “small commercial refrigeration system” or “chillers.” The compositions provided herein may be used in similar type systems or, in certain embodiments, in any alternative system where R-134a is or may be adapted for use as a refrigerant.

### EXAMPLES

The following examples are provided for the purpose of illustrating the present invention but without limiting the scope thereof.

### Example 1

### Performance in Stationary Refrigeration (Commercial Refrigeration)—Medium Temperature Applications

The performance of some preferred compositions were evaluated against other refrigerant compositions at conditions typical of medium temperature refrigeration. This application covers the refrigeration of fresh food. The conditions at which the compositions were evaluated are shown in Table 1:

TABLE 1

| Evaporating Temperature | 17.6° F. | (−8° C.) |
|---|---|---|
| Condensing Temperature | 113° F. | (45° C.) |
| Evaporator Superheat | 10° F. | (5.5° C.) |
| Condenser Subcooling | 10° F. | (5.5° C.) |
| Compressor Displacement | 1.0 ft³/min (0.028 m³/min) | |
| Compressor Isentropic Eff. | 65% | |
| Suction Line Superheat | 18° F. | (10° C.) |

Table 2 compares compositions of interest to the baseline refrigerant, R-134a.

TABLE 2

| | | | Ev. | | | Press. | Suc. | Dis. | Dis. |
|---|---|---|---|---|---|---|---|---|---|
| | | | Glide | Cap. | COP | Ratio | Press. | Press. | Temp. |
| Components | Composition | GWP | (° C.) | (%) | (%) | (%) | (%) | (%) | (° C.) |
| R134a | 1.00 | 1430 | 0 | 100 | 100 | 100 | 100 | 100 | 85 |
| R1234ze | 1.00 | 6 | 0 | 74 | 100 | 103 | 74 | 76 | 75 |
| R134a/R134ze(E) | (0.42/0.58) | 604 | 0.45 | 87 | 100 | 101 | 88 | 89 | 79 |
| R1234ze(E)/R227ea | (0.95/0.05) | 167 | 0 | 73 | 99 | 103 | 74 | 76 | 75 |
| R1234ze(E)/R227ea | (0.90/0.10) | 327 | 0 | 73 | 99 | 103 | 74 | 76 | 74 |
| R1234ze(E)/R227ea | (0.88/0.12) | 392 | 0 | 73 | 99 | 103 | 74 | 76 | 73 |
| R1234ze(E)/R227ea | (0.85/0.15) | 488 | 0 | 73 | 99 | 103 | 74 | 76 | 73 |
| R1234ze(E)/R227ea | (0.80/0.20) | 649 | 0 | 72 | 98 | 103 | 74 | 76 | 72 |
| R1234ze(E)/R227ea/R134a | (0.85/0.10/0.05) | 399 | 0.16 | 75 | 99 | 102 | 76 | 77 | 74 |
| R1234ze(E)/R227ea/R134a | (0.80/0.10/0.10) | 470 | 0.28 | 77 | 99 | 102 | 77 | 79 | 75 |
| R1234ze(E)/R227ea/R134a | (0.75/0.10/0.15) | 541 | 0.37 | 78 | 99 | 102 | 79 | 81 | 75 |
| R1234ze(E)/R227ea/R134a | (0.83/0.12/0.05) | 463 | 0.16 | 75 | 99 | 102 | 76 | 77 | 74 |
| R1234ze(E)/R227ea/R134a | (0.78/0.12/0.10) | 534 | 0.28 | 76 | 99 | 102 | 77 | 79 | 75 |
| R1234ze(E)/R227ea/R134a | (0.73/0.12/0.15) | 605 | 0.37 | 78 | 99 | 102 | 79 | 81 | 75 |
| R1234ze(E)/R227ea/R134a | (0.80/0.15/0.05) | 559 | 0.16 | 74 | 99 | 102 | 76 | 77 | 73 |
| R1234ze(E)/R227ea/R134a | (0.75/0.15/0.10) | 631 | 0.28 | 76 | 99 | 102 | 77 | 79 | 74 |
| R1234ze(E)/R227ea/R134a | (0.70/0.15/0.15) | 702 | 0.37 | 78 | 99 | 102 | 79 | 81 | 75 |

As can be seen from the Table 2 above, applicants have found that the compositions of the present invention are capable of at once achieving many of the important performance parameters sufficiently close to the parameters for R-134a to permit such compositions to be used as in new medium temperature refrigeration systems. For example, the compositions exhibit capacities in this refrigeration system that is within about 30%, and even more preferably within about 25% of that of R-134a. All these blends show efficiencies (COP) very similar to R134a which is very desirable. The compositions exhibit an evaporator glide less than about 1° C. and about 10° C. lower discharge temperatures both of which are very useful for medium temperature refrigeration applications. The compositions exhibit suction and discharge pressures which are about 20% lower than R134a which is also very desirable. Especially in view of the improved GWP, the compositions of the present invention offer a reduction of more than 50% making them excellent candidates for use in new equipment for medium temperature refrigeration applications.

Those skilled in the art will appreciate that the present compositions are capable of providing the substantial advantage of a refrigerant with low GWP and small glide for use in new or newly designed refrigeration systems, including preferably, medium temperature refrigeration systems.

### Example 2

### Performance in Stationary Refrigeration (Commercial Refrigeration)—Medium Temperature Applications with Suction Line Heat Exchanger

The performance of some preferred compositions were evaluated against other refrigerant compositions at conditions typical of medium temperature refrigeration by including a suction line heat exchanger. This application covers the refrigeration of fresh food. The conditions at which the compositions were evaluated are shown in Table 3:

TABLE 3

| Evaporating Temperature | 17.6° F. | (−8° C.) |
|---|---|---|
| Condensing Temperature | 113° F. | (45° C.) |
| Evaporator Superheat | 10° F. | (5.5° C.) |
| Condenser Subcooling | 10° F. | (5.5° C.) |
| Compressor Displacement | 1.0 ft³/min (0.028 m³/min) | |
| Compressor Isentropic Eff. | 65% | |
| Suction Line Superheat | 10° F. | (5.5° C.) |

| | |
|---|---|
| SLHX Effectiveness | 0.8 |

Table 4 compares compositions of interest to the baseline refrigerant, R-134a.

TABLE 4

| | | | Ev. | | | Pres. | Suction | Dis. | Dis. |
|---|---|---|---|---|---|---|---|---|---|
| | | | Glide | Cap. | COP | Ratio | Pressure | Pres. | Temp. |
| Components | Composition | GWP | (° C.) | (%) | (%) | (%) | (%) | (%) | (° C.) |
| R134a | 1.00 | 1430 | 0.00 | 100 | 100 | 100 | 100 | 100 | 111 |
| R1234ze | 1.00 | 6 | 0.00 | 75 | 102 | 103 | 73 | 76 | 102 |
| R134a/R134ze(E) | (0.42/0.58) | 604 | 0.53 | 88 | 101 | 101 | 88 | 89 | 105 |
| R1234ze(E)/R227ea | (0.95/0.05) | 167 | 0.00 | 75 | 102 | 103 | 74 | 76 | 101 |
| R1234ze(E)/R227ea | (0.90/0.10) | 327 | 0.00 | 75 | 102 | 103 | 74 | 76 | 100 |
| R1234ze(E)/R227ea | (0.88/0.12) | 392 | 0.00 | 75 | 102 | 103 | 74 | 76 | 100 |
| R1234ze(E)/R227ea | (0.85/0.15) | 488 | 0.00 | 75 | 102 | 103 | 74 | 76 | 99 |
| R1234ze(E)/R227ea | (0.80/0.20) | 649 | 0.00 | 75 | 102 | 103 | 74 | 76 | 98 |
| R1234ze(E)/R227ea/R134a | (0.85/0.10/0.05) | 399 | 0.20 | 77 | 102 | 102 | 76 | 77 | 100 |
| R1234ze(E)/R227ea/R134a | (0.80/0.10/0.10) | 470 | 0.36 | 79 | 102 | 102 | 77 | 79 | 101 |
| R1234ze(E)/R227ea/R134a | (0.75/0.10/0.15) | 541 | 0.46 | 80 | 102 | 102 | 79 | 81 | 101 |
| R1234ze(E)/R227ea/R134a | (0.83/0.12/0.05) | 463 | 0.20 | 77 | 102 | 102 | 76 | 77 | 100 |
| R1234ze(E)/R227ea/R134a | (0.78/0.12/0.10) | 534 | 0.36 | 79 | 102 | 102 | 77 | 79 | 100 |
| R1234ze(E)/R227ea/R134a | (0.73/0.12/0.15) | 605 | 0.46 | 80 | 102 | 102 | 79 | 81 | 101 |
| R1234ze(E)/R227ea/R134a | (0.80/0.15/0.05) | 559 | 0.20 | 77 | 102 | 102 | 76 | 77 | 99 |
| R1234ze(E)/R227ea/R134a | (0.75/0.15/0.10) | 631 | 0.36 | 79 | 102 | 102 | 77 | 79 | 100 |
| R1234ze(E)/R227ea/R134a | (0.70/0.15/0.15) | 702 | 0.46 | 80 | 101 | 102 | 79 | 81 | 100 |

### Example 3

### Performance in Centrifugal Chiller—Air Conditioning Applications

An analysis was conducted for medium pressure refrigerants using specific speed and diameter approach as discussed in Biederman et at (2004), in order to size single-stage compressors for alternative low global warming refrigerants. Using the same specific speed (0.76) and specific diameter (3.4), the resulting compressor speed N and diameter D is given by:

$$\begin{matrix}N = 0.76 \frac{{H}^{0.75}}{\sqrt{Q}} & ( 1 a ) \\ D = 3.4 \frac{\sqrt{Q}}{{H}^{0.25}} & ( 1 b )\end{matrix}$$

Where H=Isentropic enthalpy rise or “Head” in J/kg and
Q=Volumetric flow rate in m³/s.
   Cycle analyses and compressor sizing were conducted for HFC-134a and blends shown in table 6. A refrigerant capacity of 500 tons (1760 kW) was selected assuming evaporation and condensation temperatures of 5 and 35° C., respectively. The cycle analyses yielded the values for isentropic enthalpy rise and volumetric flow rate needed to determine the speed and compressor impeller diameters using equations 1a and 1b.

The performance of some preferred compositions were evaluated against other refrigerant compositions at conditions typical for water chillers. The conditions at which the compositions were evaluated are shown in Table 5:

TABLE 5

| | | |
|---|---|---|
| Evaporating Temperature | 41° F. | (5° C.) |
| Condensing Temperature | 95° F. | (35° C.) |
| Evaporator Superheat | 5° F. | (3° C.) |
| Condenser Subcooling | 0° F. | (0° C.) |

| | |
|---|---|
| Capacity | 500 Ton (1758 kW) |
| Compressor Specific Speed | 0.76 |
| Compressor Specific Diameter | 3.4 |

Table 6 compares compositions of interest to the baseline refrigerant, R-134a.

TABLE 6

| | | | Impeller | Impeller | Tip | Pressure | |
|---|---|---|---|---|---|---|---|
| | | | Speed | Diameter | Speed | Ratio | COP |
| Components | Composition | GWP | (%) | (%) | (m/s) | (%) | (%) |
| R-134a | | 1430 | 100 | 100 | 181 | 2.54 | 100 |
| R1234ze | | 6 | 82 | 117 | 174 | 2.57 | 100 |
| R134a/R134ze(E) | (0.42/0.58) | 604 | 90 | 108 | 176 | 2.55 | 99 |
| R1234ze(E)/R227ea | (0.95/0.05) | 167 | 81 | 117 | 172 | 2.57 | 100 |
| R1234ze(E)/R227ea | (0.90/0.10) | 327 | 80 | 118 | 170 | 2.57 | 100 |
| R1234ze(E)/R227ea | (0.88/0.12) | 392 | 79 | 118 | 170 | 2.57 | 100 |
| R1234ze(E)/R227ea | (0.85/0.15) | 488 | 78 | 119 | 169 | 2.57 | 99 |
| R1234ze(E)/R227ea | (0.80/0.20) | 649 | 77 | 120 | 167 | 2.57 | 99 |
| R1234ze(E)/R227ea/R134a | (0.85/0.10/0.05) | 399 | 81 | 117 | 171 | 2.57 | 99 |
| R1234ze(E)/R227ea/R134a | (0.80/0.10/0.10) | 470 | 82 | 116 | 171 | 2.57 | 99 |
| R1234ze(E)/R227ea/R134a | (0.75/0.10/0.15) | 541 | 83 | 115 | 171 | 2.56 | 99 |
| R1234ze(E)/R227ea/R134a | (0.83/0.12/0.05) | 463 | 80 | 117 | 170 | 2.57 | 99 |
| R1234ze(E)/R227ea/R134a | (0.78/0.12/0.10) | 534 | 81 | 116 | 170 | 2.57 | 99 |
| R1234ze(E)/R227ea/R134a | (0.73/0.12/0.15) | 605 | 82 | 115 | 171 | 2.56 | 99 |
| R1234ze(E)/R227ea/R134a | (0.80/0.15/0.05) | 559 | 79 | 118 | 169 | 2.57 | 99 |
| R1234ze(E)/R227ea/R134a | (0.75/0.15/0.10) | 631 | 80 | 117 | 169 | 2.57 | 99 |
| R1234ze(E)/R227ea/R134a | (0.70/0.15/0.15) | 702 | 81 | 115 | 170 | 2.56 | 99 |

### Example 4

### Flammability Properties of the Binary Blend 1234ze(E)/227ea

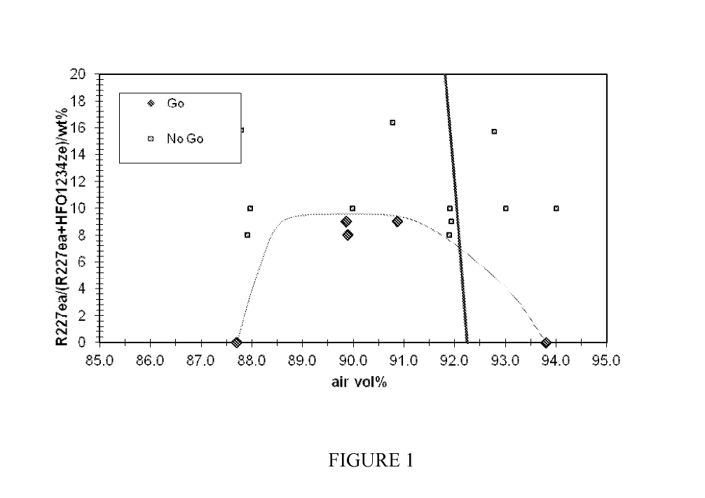

FIG. 1 shows plots the contents of 227ea in a binary blend with 1234ze(E) (vertical axis) against the vol fraction of the blend in air. The curved line describes the flammable boundary. Within the curved line boundary, mixtures are flammable, and outside of the curved line boundary, mixtures are non-flammable. The blue line describes the stochiometric composition of the binary blend in air.

The FIGURE shows that 10% wt or more HFC-227ea would suppress the flammability of HFO-1234ze(E). The typical laboratory experimental error/variability is estimated as being +5% (positive due to safety), giving the most preferred range of 10% to 15%. Typical inter-laboratories variability for these mildly flammable material further expand the variability by +/−2%, therefore, the mixture range is increased to 8% to 17% of 227ea, giving a wider desirable range. Further with the mild flammability of 1234ze(E) and varying published data for its flammability, an even wider acceptable range is from 5% to 20% of 227ea.

### Example 5

### Performance in Positive Displacement Chillers—Air Conditioning Applications

The performance of some preferred compositions were evaluated against other refrigerant compositions at conditions typical of chillers which can employ both positive-displacement or screw type compressors. The conditions at which the compositions were evaluated are shown in Table 7:

TABLE 7

| | | |
|---|---|---|
| Evaporating Temperature | 41.9° F. | (5.5° C.) |
| Condensing Temperature | 122° F. | (50° C.) |
| Evaporator Superheat | 10° F. | (5.5° C.) |
| Condenser Subcooling | 10° F. | (5.5° C.) |

| | |
|---|---|
| Compressor Displacement | 1.0 ft³/min (0.028 m³/min) |
| Compressor Isentropic Eff. | 75% |

Table 8 compares compositions of interest to the baseline refrigerant, R-134a.

TABLE 8

| | | | Ev. | | | Press. | Suc. | Dis. | Dis. |
|---|---|---|---|---|---|---|---|---|---|
| | | | Glide | Cap. | COP | Ratio | Press. | Press. | Temp. |
| Components | Composition | GWP | (° C.) | (%) | (%) | (%) | (%) | (%) | (° C.) |
| R134a | 1.00 | 1430 | 0 | 100 | 100 | 100 | 100 | 100 | 68 |
| R1234ze | 1.00 | 6 | 0 | 75 | 100 | 102 | 74 | 76 | 61 |
| R134a/R134ze(E) | (0.42/0.58) | 604 | 0.48 | 88 | 100 | 101 | 88 | 89 | 64 |
| R1234ze(E)/R227ea | (0.95/0.05) | 167 | 0 | 74 | 100 | 102 | 74 | 76 | 60 |
| R1234ze(E)/R227ea | (0.90/0.10) | 327 | 0 | 74 | 100 | 102 | 74 | 76 | 60 |
| R1234ze(E)/R227ea | (0.88/0.12) | 392 | 0 | 74 | 99 | 102 | 74 | 76 | 59 |
| R1234ze(E)/R227ea | (0.85/0.15) | 488 | 0 | 74 | 99 | 102 | 74 | 76 | 59 |
| R1234ze(E)/R227ea | (0.80/0.20) | 649 | 0 | 73 | 99 | 102 | 74 | 76 | 59 |
| R1234ze(E)/R227ea/R134a | (0.85/0.10/0.05) | 399 | 0.17 | 76 | 100 | 102 | 76 | 77 | 60 |
| R1234ze(E)/R227ea/R134a | (0.80/0.10/0.10) | 470 | 0.30 | 77 | 100 | 102 | 78 | 79 | 61 |
| R1234ze(E)/R227ea/R134a | (0.75/0.10/0.15) | 541 | 0.40 | 79 | 99 | 102 | 80 | 81 | 61 |
| R1234ze(E)/R227ea/R134a | (0.83/0.12/0.05) | 463 | 0.17 | 76 | 99 | 102 | 76 | 77 | 60 |
| R1234ze(E)/R227ea/R134a | (0.78/0.12/0.10) | 534 | 0.30 | 77 | 99 | 102 | 78 | 79 | 60 |
| R1234ze(E)/R227ea/R134a | (0.73/0.12/0.15) | 605 | 0.40 | 79 | 99 | 101 | 80 | 81 | 61 |
| R1234ze(E)/R227ea/R134a | (0.80/0.15/0.05) | 559 | 0.17 | 75 | 99 | 102 | 76 | 77 | 60 |
| R1234ze(E)/R227ea/R134a | (0.75/0.15/0.10) | 631 | 0.30 | 77 | 99 | 102 | 78 | 79 | 60 |
| R1234ze(E)/R227ea/R134a | (0.70/0.15/0.15) | 702 | 0.39 | 79 | 99 | 101 | 80 | 81 | 61 |

As can be seen from the Table 8 above, applicants have found that the compositions of the present invention are capable of at once achieving many of the important performance parameters sufficiently close to the parameters for R-134a to permit such compositions to be used as in chillers systems. For example, the compositions exhibit capacities in this refrigeration system that is within about 30%, and even more preferably within about 25% of that of R-134a. All these blends show efficiencies (COP) very similar to R134a which is very desirable. The compositions exhibit an evaporator glide less than about 1° C. and about 10° C. lower discharge temperatures both of which are very useful for these applications. The compositions exhibit suction and discharge pressures which are about 20% lower than R134a which is also very desirable. Especially in view of the improved GWP, the compositions of the present invention offer a reduction of more than 50% making them excellent candidates for use in new equipment for medium temperature refrigeration applications.

Those skilled in the art will appreciate that the present compositions are capable of providing the substantial advantage of a refrigerant with low GWP and small glide for use in new or newly designed refrigeration systems, including preferably, centrifugal chillers.

What is claimed is:

1. A heat transfer composition comprising: (a) HFO-1234ze; (b) HFC-227ea; and (c) optionally HFC-134a, wherein HFO-1234ze and HFC-227ea are provided in effective amounts to form an azeotrope or azeotrope-like composition.

2. The heat transfer composition of claim 1, where HFO-1234ze consists essentially of trans-HFO-1234ze.

3. The heat transfer composition of claim 1 comprising (a) from about 80 wt. % to about 95 wt. % of HFO-1234ze; and (b) from about 5 wt. % to about 20 wt. % of HFC-227ea, with the weight percent being based on the total of the components (a)-(c) in the composition.

4. The heat transfer composition of claim 1 comprising (a) from about 83 wt. % to about 92 wt. % of HFO-1234ze; and (b) from about 8 wt. % to about 17 wt. % of HFC-227ea, with the weight percent being based on the total of the components (a)-(c) in the composition.

5. The heat transfer composition of claim 1 comprising (a) from about 85 wt. % to about 90 wt. % of HFO-1234ze; and (b) from about 10 wt. % to about 15 wt. % of HFC-227ea, with the weight percent being based on the total of the components (a)-(c) in the composition.

6. The heat transfer composition of claim 1 comprising (a) from about 88 wt. % to about 95 wt. % of HFO-1234ze; and (b) from about 8 wt. % to about 12 wt. % of HFC-227ea, with the weight percent being based on the total of the components (a)-(c) in the composition.

7. The heat transfer composition of claim 1 comprising (a) from about 60 wt. % to about 95 wt. % of HFO-1234ze; (b) from about 5 wt. % to about 20 wt. % of HFC-227ea, (c) from greater than about 0 wt. % to about 20 wt. % of HFC-134a, with the weight percent being based on the total of the components (a)-(c) in the composition.

8. The heat transfer composition of claim 1 comprising (a) from about 68 wt. % to about 92 wt. % of HFO-1234ze; (b) from about 8 wt. % to about 17 wt. % of HFC-227ea, (c) from greater than about 0 wt. % to about 15 wt. % of HFC-134a, with the weight percent being based on the total of the components (a)-(c) in the composition.

9. The heat transfer composition of claim 1 comprising (a) from about 75 wt. % to about 90 wt. % of HFO-1234ze; (b) from about 10 wt. % to about 15 wt. % of HFC-227ea, (c) from greater than about 0 wt. % to about 10 wt. % of HFC-134a, with the weight percent being based on the total of the components (a)-(c) in the composition.

10. The heat transfer composition of claim 1 comprising (a) from about 80 wt. % to about 90 wt. % of HFO-1234ze; (b) from about 10 wt. % to about 15 wt. % of HFC-227ea, (c) from greater than about 0 wt. % to about 5 wt. % of HFC-134a, with the weight percent being based on the total of the components (a)-(c) in the composition.

11. A refrigeration system comprising the heat transfer composition of claim 1.

12. The refrigeration system of claim 11 being in a unit selected from the group consisting of small refrigeration systems, low- and medium-temperature refrigeration systems, stationary air conditioners, automotive air conditioners, domestic refrigerator/freezers, chillers, heat pumps, vending machines, screw water chillers, centrifugal water chillers, medium pressure centrifugal chillers, heat pump water heaters, and dehumidifiers.

13. The heat transfer composition of claim 1 further comprising up to about 5% by weight of a compound selected from the group consisting of HFC-152a, HFO-1234yf, HFC-236ea, HFC-245fa, CO2.

14. A method of replacing an existing heat transfer fluid contained in heat transfer system comprising removing at least a portion of said existing heat transfer fluid from said system, said existing heat transfer fluid comprising HFC-134a and replacing at least a portion of said existing heat transfer fluid by introducing into said system a heat transfer composition comprising: (a) HFO-1234ze; (b) HFC-227ea; and (c) optionally HFC-134a, wherein HFO-1234ze and HFC-227ea are provided in effective amounts to form an azeotrope or azeotrope-like composition.

15. A heat transfer system comprising a compressor, a condenser and an evaporator in fluid communication, and a heat transfer composition in said system, said heat transfer composition comprising: (a) HFO-1234ze; (b) HFC-227ea; and (c) optionally HFC-134a, wherein HFO-1234ze and HFC-227ea are provided in effective amounts to form an azeotrope or azeotrope-like composition.
